(19) United States
(12) Patent Application Publication
(10) Pub. No.: US 2002/0165865 A1
(43) Pub. Date: Nov. 7, 2002

(54) Data operating device for providing schema with freedom in data operation of object-oriented database

(75) Inventor: Hideatsu Hosokai, Kawasaki (JP)

Correspondence Address: Patrick G. Burns, Esq., GREER, BURNS & CRAIN, LTD., Suite 2500, 300 South Wacker Dr., Chicago, IL, 60606, US

(73) Assignee: FUJITSU LIMITED

(21) Appl. No.: 10/113,601

(22) Filed: Mar. 29, 2002

(30) Foreign Application Priority Data
May 7, 2001 (JP) 2001-136443

(51) Int. Cl. G06F 7/00

(52) U.S. Cl. 707/100

(57) ABSTRACT

Definition information for defining a tuple with an unspecific schema in the superclass of all the tuple type classes of a hierarchical class structure is stored in the definition information storage unit of a data operating device for operating on the data of an object-oriented database. If a tuple variable is declared using the tuple defined based on this definition information, an assignment unit assigns a tuple with an arbitrary schema to the tuple variable.

### BACKGROUND OF THE INVENTION

1. Field of the Invention

The present invention relates to information processing of operating on data stored in a database.

2. Description of the Related Art

If in the retrieval of a database, the schema of a retrieval result is predetermined, and, for example, a syntax, such as the “select” command of a structured query language (SQL) can be used. A schema is a data structure and it indicates how many pieces of what types of data are combined and the like. As long as the schema of a retrieval result and the schema to which the retrieval result is assigned are the same, an obtained retrieval result can be used in a subsequent process using the same variable. This also applies to the case where a retrieval result is obtained by executing a method (procedure).

Therefore, for example, if a plurality of retrievals are conducted and if the schemas of the tuples of the plurality of retrieval results are different, a program developer and the like must understand the schema of each retrieval result and must define a tuple with the same schema as that of each retrieval result. A tuple is of a string data type, such as an array. Both the schema of a retrieval result and the definition of a tuple are described below with reference to FIG. 1. As shown in FIG. 1, it is assumed that the schema of the first retrieval result is the schema [A, B] of the combination of data type A and data type B, and the schema of the second retrieval result is the schema [A, B, C] of the combination of data type A, data type B and data type C. In this case, the program developer and the like must define both tuple T1 with the same schema as the schema [A, B] of the first retrieval result and tuple T2 with the same schema as the schema [A, B, C] of the second result.

If a method using each retrieval result for a return value is defined, the program developer must further define a class with a method using a tuple with the same schema as the schema of each retrieval result for a return value. The definition of a class with a method using a tuple with a different schema for a return value is described below with reference to FIG. 2. In FIG. 2, each of the schemas of tuples T1 and T2 has a different schema. In this case, the program developer and the like must define a method with both method m1 ( ) using tuple T1 for a return value and method m2 ( ) using tuple T2 for a return value.

The program developer and the like also must declare a variable for receiving each retrieval result to be a tuple variable with the same schema as the schema of the retrieval result. In this variable declaration, the program developer and the like first defines a tuple with the same schema as the schema of the retrieval result and declares a variable using the tuple. The declaration of a tuple variable is described below with reference to FIG. 3. In FIG. 1, tuples T1 and T2, each of which has the same schema as that of each retrieval result, were defined. In FIG. 3, it is found that variables t1 and t2 are declared using tuples T1 and T2, respectively, defined in FIG. 1.

In this way, the schemas of a variable or the return value of a method are defined. Then, it is judged whether a retrieval result can be assigned, based on both the schema of the retrieval result and the schema of a tuple variable to which the retrieval result is assigned or the return value of a method. If it is judged that the retrieval result can be assigned, a subsequent process can be performed. In this case, whether the retrieval result can be assigned is judged based on both whether the number of attributes of a tuple variable or the schema of a return value and the number of attributes of the schema of the retrieval result are the same and whether the data types of the attributes of the schema of the retrieval result corresponding to the order of the attribute of the variable or the schema of the return value can be assigned to each other.

As described above, according to the prior art, in both a relational database and an object-oriented database, the tuple schema of a retrieval result to be retrieved was predetermined and a process for using the retrieval result is described based on the determination. Since the schema of a retrieval result is fixed by this determination, a retrieval process in which the schema of a retrieval result dynamically changes could not be performed, which is a problem. Furthermore, this fact restricted the program development of the program developer and the like, which is another problem.

In order to understand the schema of a retrieval result in advance, the program developer and the like must define a tuple with the same schema as the schema of the retrieval result in the development stage of a program. If, in particular, there are a variety of patterns of the schema of a retrieval result, this tuple definition was a burden in the installation of a program, which is another problem.

### SUMMARY OF THE INVENTION

It is an object of the present invention to solve the problems described above, in particular, problems associated with the program development of an object-oriented database.

According to one aspect of the present invention, a data operating device for operating on data stored in a database comprises a definition information storage unit storing definition information for defining a tuple with an unspecific schema, a variable management unit managing tuple variables and an assignment unit assigning a tuple with an arbitrary schema to a tuple variable if the tuple variable to be managed by the variable management unit is the tuple which is defined by the definition information and the schema which is not specified. A tuple with an unspecific schema hereinafter is called a schema-variable tuple.

By defining a tuple with an unspecific schema, a tuple with an arbitrary schema can be assigned to a variable declared using this defined tuple. Thus, the load that is due to the tuple definition made by a program developer and that is caused at the time of program development can be reduced. The schema-variable tuple described above can be defined in the superclass of all tuple type classes in the hierarchical class structure of an object-oriented database.

In the configuration described above, when a tuple is assigned to a schema-variable tuple variable, the assignment unit may further set the class information of a tuple to be assigned, as the type information of a variable. The set type information is stored in a type information storage unit storing type information. Type information is information about the type of a tuple, that is, how many pieces of what information are used in what order. By setting type information, the assignment unit can judge whether a schema-variable tuple variable can be assigned to another tuple variable (normal tuple variable), the schema of which is determined at the time of variable declaration, after a tuple is assigned to the schema-variable tuple variable.

Furthermore, in the configuration described above, the data operating device can further comprise a reset unit restoring type information set by the assignment unit to the initial state. Thus, another tuple with a schema different from that of a tuple to be assigned can be further assigned after the tuple is assigned to a schema-variable tuple variable.

In the configuration described above, the variable management unit can manage the tuple of the return value of a method and the assignment unit can also use a tuple with an arbitrary schema for the return value of the method if the method has the return value of a schema-variable tuple.

By using a schema-variable tuple for the return value of a method, the schema of the return value of the method can be variable. Thus, a program for dynamically changing the schema of the return value of the method can be generated.

According to another aspect of the present invention, a data operating method of an object-oriented database comprises storing definition information for defining a tuple with an unspecific schema in a storage unit and assigning a tuple with an arbitrary schema to the tuple type variable that is defined based on definition information stored in the storage unit. By this method too, the same functions and effects as those of the aspect described above can be obtained.

The problems described above can also be solved by loading a program for enabling a computer to implement the same functions as those performed by each of the configurations of the present inventions described above and by enabling the computer to execute the program. The program described above can also be loaded by enabling the computer to read the program described above from a storage medium storing the program. Alternatively, a computer can receive computer data signals representing the program described above embodied in a carrier wave and the program represented by the received signals can be loaded into the computer.

### BRIEF DESCRIPTION OF THE DRAWINGS

The features and advantages of the present invention will be more clearly appreciated from the following description taken in conjunction with the accompanying drawings in which like elements are denoted by like reference numerals and in which:

FIG. 1 is a diagram explaining both the retrieval result of a schema and the definition of a tuple;

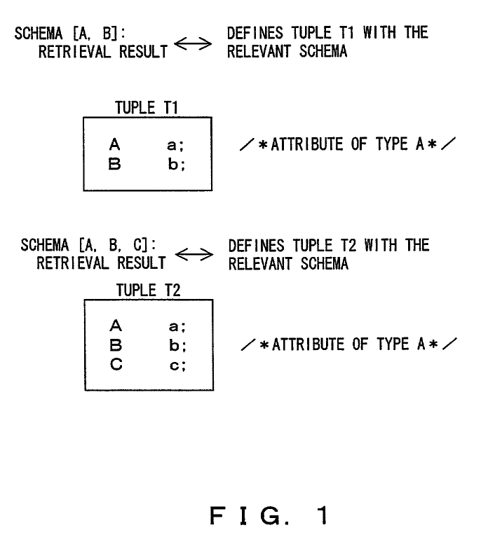

FIG. 2 is a diagram explaining the definition of a class that has methods, each of which uses a tuple for a return value and in which the tuples are different from each other;

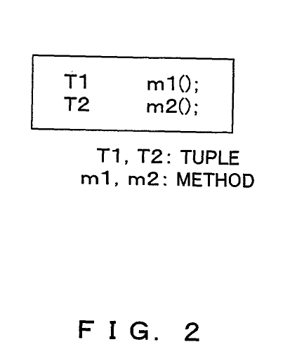

FIG. 3 is a diagram explaining the declaration of a tuple variable;

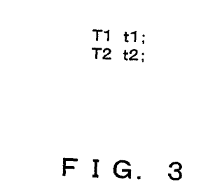

FIG. 4 shows the configuration of the data operating device according to the preferred embodiment of the present invention;

FIG. 5 is a flowchart showing the process of declaring a schema-variable tuple variable and assigning a tuple to the variable;

FIG. 6 is a flowchart showing the process of assigning a schema-variable tuple variable to which a tuple has been assigned to another variable;

FIG. 7 is a diagram explaining the process of assigning a tuple to a schema-variable tuple variable;

FIG. 8 is a diagram explaining the case where retrieval is conducted using a schema-variable tuple;

FIG. 9 is a diagram explaining the case where a schema-variable tuple is used for the return value of a method;

FIG. 10 shows the configuration of the computer;

FIG. 11 shows the loading of programs and data into the computer.

### DESCRIPTION OF THE PREFERRED EMBODIMENTS

The preferred embodiments of the present invention are described below with reference to the drawings.

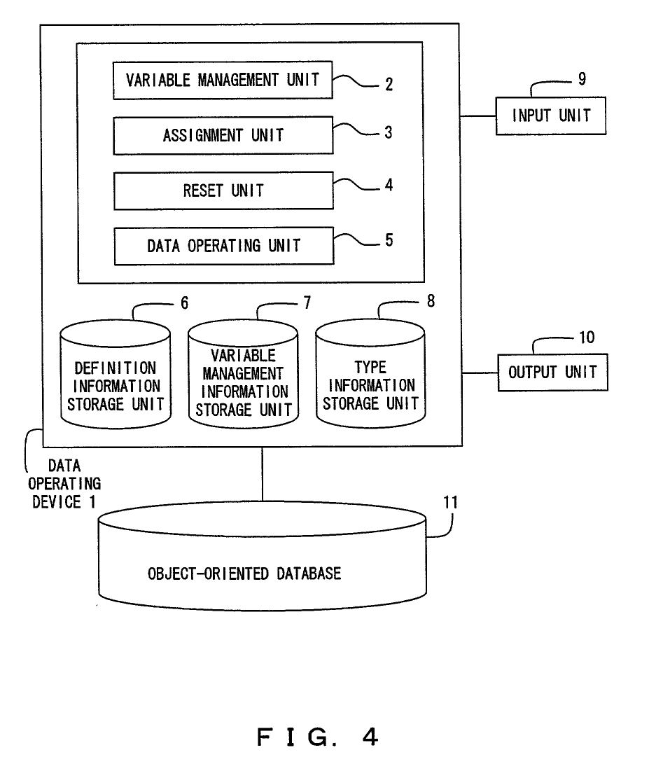

FIG. 4 shows the configuration of the data operating device of an object-oriented database according to the preferred embodiment of the present invention. As shown in FIG. 4, the data operating device 1 comprises a variable management unit 2, an assignment unit 3, a reset unit 4, a data operating unit 5, a definition information storage unit 6, a variable management information storage unit 7, a type information storage unit 8, an input unit 9 and an output unit 10. The data operating device 1 is directly connected to an object-oriented database 11 to be operated or is indirectly connected to the database through a network, which is not shown in FIG. 4.

The definition information storage unit 6 stores definition information for defining a tuple with an unspecific schema. One of the features of the present invention is the definition of this schema-variable tuple. A tuple with such an unspecific schema is called a schema-variable tuple hereinafter. In an object-oriented database, a hierarchical structure can be defined for a class. In such a hierarchical class structure of an object-oriented database, a schema-variable tuple can also be defined in the superclass of all classes of the other tuple types.

The variable management unit 2 manages tuple variables and stores variable management information indicating the schema of a tuple variable in the variable management information storage unit 7. If the tuple variable is a schema-variable tuple variable, the variable management information indicates that the schema is variable instead of indicating the schema of the tuple variable. The assignment unit 3 can judge whether a variable to which a tuple is assigned is a schema-variable tuple variable or a normal tuple variable, that is, a tuple variable with a schema declared at the time of variable declaration based on the variable management information stored in the variable management unit 7.

To assign a tuple to the schema-variable tuple variable, if type information has not yet been set in the variable, the assignment unit 3 assigns the tuple to the schema-variable tuple variable, sets the class information of the tuple to be assigned as the type information of the variable and stores the set type information in the type information storage unit 8. On the other hand, if the type information has already been set after a tuple is assigned to a schema-variable tuple variable, to further assign another tuple to the variable, the assignment unit 3 judges whether the other tuple can be assigned to the variable based on both the type information of the variable to which the other tuple is assigned and which is stored in the type information storage unit 8, and the schema of the other tuple to be assigned. If it is judged that the other tuple is assignable, the other tuple is assigned to the variable.

As described above, the schema of a schema-variable tuple variable is not determined when the variable is defined, and the schema is determined when a tuple (value) is assigned to the variable. Thus, if the variable is further assigned to a normal tuple variable after a tuple is assigned to the schema-variable tuple variable, the assignment unit 3 can judge whether the variable is assignable.

The reset unit 4 resets the type information stored in the type information storage unit 8 and restores the type information to the initial state, that is, a state where there is no type information, according to an instruction. In this way, even if a tuple has been assigned to a schema-variable tuple variable, a tuple with an arbitrary schema can be assigned to the variable again.

The data operating unit 5 operates on data stored in the object-oriented database 11. Since the functions of this data operating unit 5 are the same as those of the prior art, the description is omitted.

The input unit 9 and output unit 10 are used for a user/another device to input data, instructions and the like to the data operating device 1 and for the data operating device 1 to output data operating results, inquiries and the like to a user/another device, respectively.

Furthermore, the variable management 2 can also manage the return value of a method, and the assignment unit 3 can also use a tuple with an arbitrary schema for the return value of the method if the return value of the method is a schema-variable tuple. By using the return value of a method, the schema of the return value of the method can be variable. Thus, a program for dynamically changing the schema of the return value of a method can be designed.

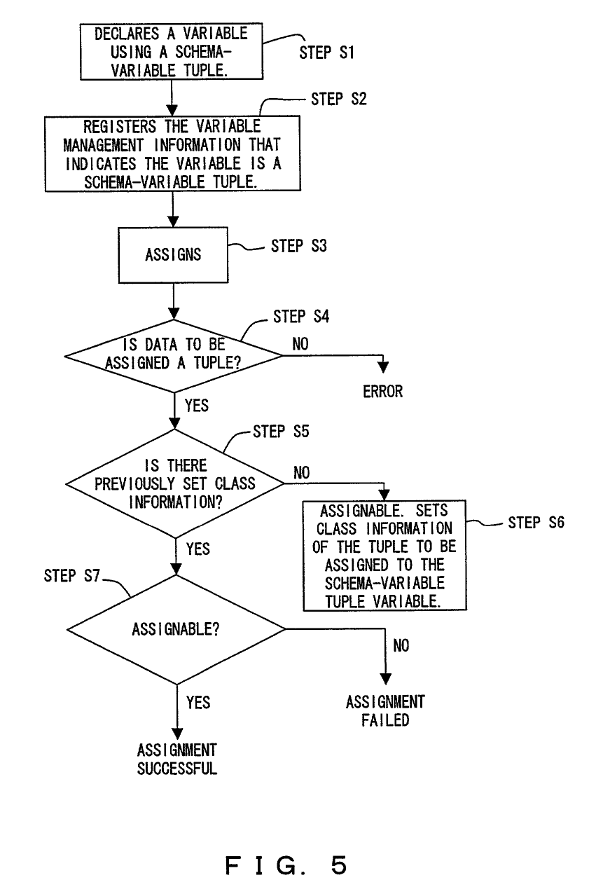

In the data operating device 1 described above, the process logic of both the declaration and assignment of a variable that is different from the prior art is adopted. First, both the declaration of a schema-variable tuple variable and the assignment of a tuple to a schema-variable tuple variable are described with reference to FIG. 5.

Definition information for defining a schema-variable tuple in the superclass of all classes of the other tuple type is stored in the definition information storage unit 5, which is not shown in FIG. 5. When a schema-variable tuple variable t is declared by input by a user and the like (step S1), the variable management unit 2 stores variable management information indicating that variable t is a schema-variable tuple, in the variable information storage unit 7 (step S2)

If the assignment unit 3 assigns the retrieval result of the object-oriented database 11 and the like to the variable t (step S3), first, the assignment unit 3 checks the tuple of the variable t by referring to the variable management information of the variable t stored in the variable management information storage unit 7. In this example, the assignment unit 3 judges that variable t is a schema-variable tuple. Then, the assignment unit 3 judges whether data to be assigned, that is, in this example, an obtained retrieval result, is a tuple (step S4). If the assignment unit 3 judges that the data to be assigned is not a tuple (No in step S4), it is judged that an assignment error occurs, and the data operating device 1 stops the process.

If the assignment unit 3 judges that the data to be assigned is a tuple (Yes in step S4), the assignment unit 3 further judges whether class information is set in schema-variable tuple variable t to which the tuple is assigned, by referring to the type information stored in the type information storage unit 8 (step S5). This is because as described above, although a schema-variable tuple variable t has no type information before a tuple is assigned, the class information of a tuple to be assigned is set as its type information until the type information set by the reset unit 4 is restored to the initial state once a tuple is assigned. Type information is information indicating how many pieces of what data (attribute) of a tuple are used in what order.

If the assignment unit 3 judges that class information is not set in a schema-variable tuple variable t to which a tuple is assigned (No in step S5), the assignment unit 3 can assign a tuple with an arbitrary schema to the variable t. The assignment unit 3 assigns the tuple to be assigned to variable t and sets the class information of the tuple as the type information of the variable t (step S6). The assignment unit 3 stores the type information set for the variable t, in the type information storage unit 8.

If the assignment unit 3 judges that class information is set for the variable t (Yes in step S5), the assignment unit 3 further judges whether the tuple to be assigned can be assigned to the variable t (step S7). If the type information of the variable t stored in the type information storage unit 8 is initialized by the reset unit 4 or if both the type information of the variable t and the schema of the tuple to be assigned indicates that the tuple to be assigned can be assigned to the variable t, the assignment unit 3 judges that the tuple to be assigned can be assigned to the variable t (Yes in step S7). In the former case, the assignment unit 3 performs the same process as that in step S6. In the latter case, the assignment unit 3 performs the same process as that of the prior art. Specifically, the judgment is made based on both whether the number of attributes of the type information of the variable t and the number of attributes of the tuple to be assigned match and whether the data type of each attribute of the tuple to be assigned corresponding to the attribute order of the type information of the variable t is assignable.

If as a result of the judgment in step S7, the assignment unit 3 judges that the tuple to be assigned cannot be assigned to the variable t (No in step S7), it is judged that an assignment error has occured, and the data operating device 1 stops operation.

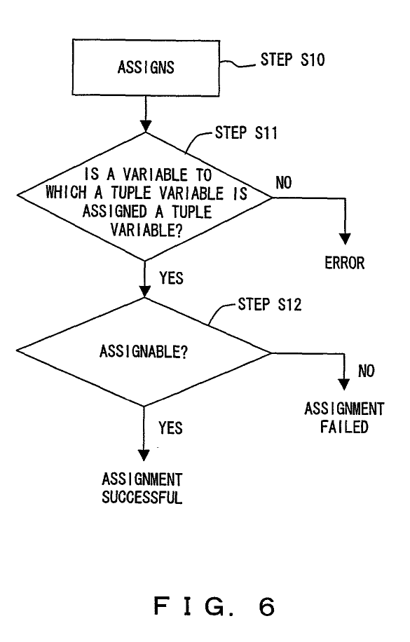

Next, the case where a schema-variable tuple variable t is assigned to a normal tuple variable after a tuple is assigned to the schema-variable tuple variable t, is described with reference to FIG. 6.

If the assignment unit 3 assigns a schema-variable tuple variable to a normal tuple variable (step S10), the assignment unit 3 judges whether the variable to which the tuple variable t is assigned is a normal tuple variable (step S11). The assignment unit 3 makes this judgment by referring to the variable management information storage unit 7 for storing variable management information indicating the schema of a tuple variable. If the assignment unit 3 does not judge that the variable to which the tuple variable t is assigned is a normal tuple variable (No in step S11), it is judged that an assignment error occurs, and the data operating device 1 stops the process.

If the assignment unit 3 judges that the variable to which the tuple variable t is assigned is a normal tuple variable (Yes in step S11), the assignment unit 3 further judges whether the assignment is possible, based on both the schema of the normal tuple variable to which the tuple variable is assigned and the type information set for the schema-variable tuple variable t to be assigned (step S12). The assignment unit 3 makes this judgment by referring to the type information of the tuple variable t stored in the type information storage unit 8. This judgment method is the same as the conventional method. If the assignment unit 3 judges that the assignment is possible (Yes in step S12), the schema-variable tuple variable t is assigned to the normal tuple variable. Since this assignment process is also the same as the conventional method, the description is omitted. If the assignment unit 3 does not judge that the assignment is possible (No in step S12), it is judged that an assignment error occurs, and the data operating device 1 stops the process. As described above, since type information is set when a tuple is assigned to a schema-variable tuple variable, a schema-variable tuple variable to which a tuple has been assigned can be further assigned to a normal tuple variable.

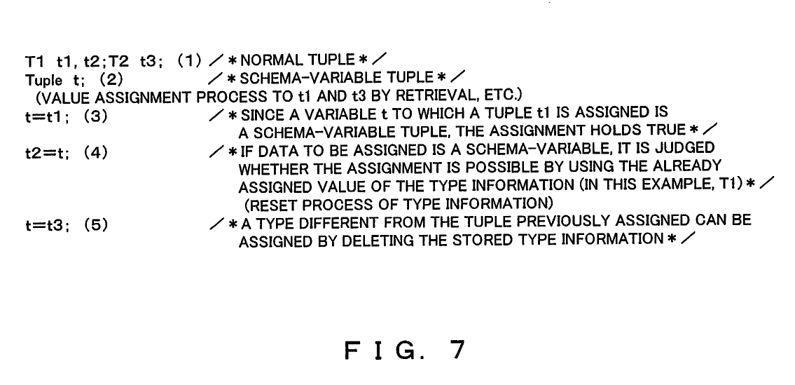

The assignment process of a schema-variable tuple is described below with reference to FIG. 7.

First, in (1) of FIG. 7, both tuple variables t1 and t2 with schema T1 and a tuple variable t3 with schema T2 are defined. Each of these variables t1, t2 and t3 is a normal tuple variable with a predetermined schema.

Then, in (2) of FIG. 7, a schema-variable tuple variable t is declared. This declaration corresponds to step S2 shown in FIG. 5. Furthermore, it is assumed that retrieval and the like is conducted after the declaration of both (1) and (2), and a tuple (value) is assigned to variables t1, t2 and t3, which is not shown in FIG. 7.

In (3) of FIG. 7, the assignment of tuple variable t1 to schema-variable tuple variable t is instructed. Since the tuple variable t1 to be assigned and the tuple variable t to which the tuple variable t1 is assigned are normal tuple and schema-variable tuple, respectively, this assignment holds true. In this assignment, the class information of the tuple variable t1 is assigned as the type information of the schema-variable tuple variable t. Thus, the schema of the variable t becomes T1. This process corresponds to steps S3 through S6 shown in FIG. 5.

Furthermore, in (4) of FIG. 7, the assignment of the schema-variable tuple variable t to the normal tuple variable t2 is instructed. In (3), the schema of the schema-variable tuple variable t is already T1. The schema of the tuple variable t2 is T1 as defined in the previous (1). Since the type information of the variable t to be assigned and the type information of the tuple variable t2 to which the variable t is assigned match, the schema-variable tuple variable t can be assigned to the normal tuple t2. Therefore, this assignment holds true. This process corresponds to steps S10 through Yes of S12 shown in FIG. 6.

As described in (3) of FIG. 7, once an assignment holds true in the assignment of a tuple to a schema-variable tuple variable, the type information of the tuple is set as the type information of the schema-variable tuple variable. However, the system can also be configured so that the set type information can be reset, as requested, for example, if there is no need for a tuple (value) assigned to a variable and the like. In that case, if the type information of the schema-variable tuple variable is restored to the initial state by resetting the set type information, even a tuple with a schema different from that of the previously assigned tuple can be assigned to the schema-variable tuple variable. In (5) of FIG. 7, the assignment of tuple t3 to the schema-variable tuple variable t after the resetting of the previously assigned type information, is instructed. Although in (3) of FIG. 7, the class information of the tuple t1 is assigned as the type information of the schema-variable tuple variable t, the assignment shown in (5) of FIG. 7 holds true since the type information is restored to the initial state. This process corresponds to steps S4 to Yes of step S7 through Yes of step S5 shown in FIG. 5.

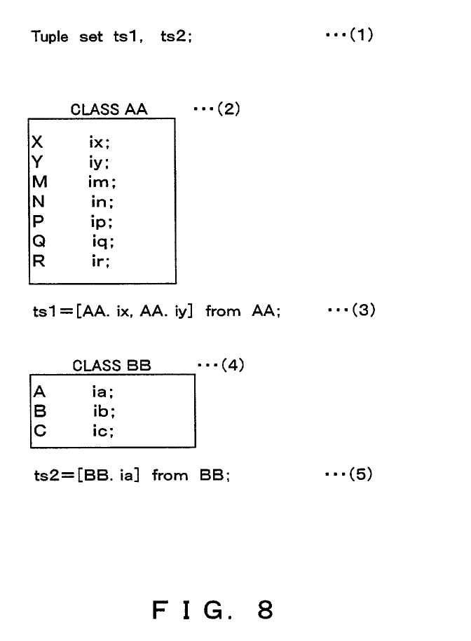

Retrieval using a schema-variable tuple is described below with reference to FIG. 8. Although a retrieval operation is described in this example, the operation of the data operating device is not limited to retrieval.

In (1) of FIG. 8, the sets ts1 and ts2 of schema-variable tuple variables are declared. The variable management unit 2 stores variable management information indicating that variables in sets ts1 and ts2 are schema-variable tuples, in the variable management information storage unit 7. Thus, a tuple with any kind of schema can be assigned to variables in sets ts1 and ts2.

Then, the data operating unit 5 retrieves all the instances of class AA with two attributes: the attribute ix of type X, the attribute iy of type Y and the like shown in (2) of FIG. 8, based on a condition. In (3) of FIG. 8, the assignment unit 3 assigns the set of tuples with the combination of the value of attribute ix and the value of attribute iy as a schema, that are obtained as a retrieval result, to the variable set ts1. The assignment unit 3 sets the class information of the retrieval result as the type information of variable set ts1 and stores the set type information in the type information storage unit 8. Thus, the schema of variable set ts1 becomes [X,Y].

Then, the data operating unit 5 retrieves all the instances of class BB with three attributes: the attribute ia of type A, the attribute ib of type B and the attribute ic of type C shown in (4) of FIG. 8, based on a condition. In (5) of FIG. 8, as in (3) of FIG. 8, the assignment unit 3 assigns the set of tuples with the value of attribute ia as a schema obtained as a retrieval result, to variable set ts2 and sets the type information of variable set ts2. Thus, the schema of variable set ts2 becomes [A]. As described above, a tuple set with an arbitrary schema can be assigned to a set of schema-variable tuple variables.

Conventionally, if a variable to receive a retrieval result is declared, the schema of the retrieval result must be predetermined and a variable set with the determined schema must be declared. Since the schema of a retrieval result is fixed by this determination, a retrieval process such that the schema of a retrieval result may dynamically change cannot be performed. However, as described above, according to this preferred embodiment, a tuple set with an arbitrary schema can be assigned to a set of schema-variable tuple variables. Therefore, if a retrieval result is configured so as to receive a retrieval result using a schema-variable tuple variable, there is no need to obtain the schema of the retrieval result in advance. Furthermore, restriction in program development by a program developer and the like can be reduced.

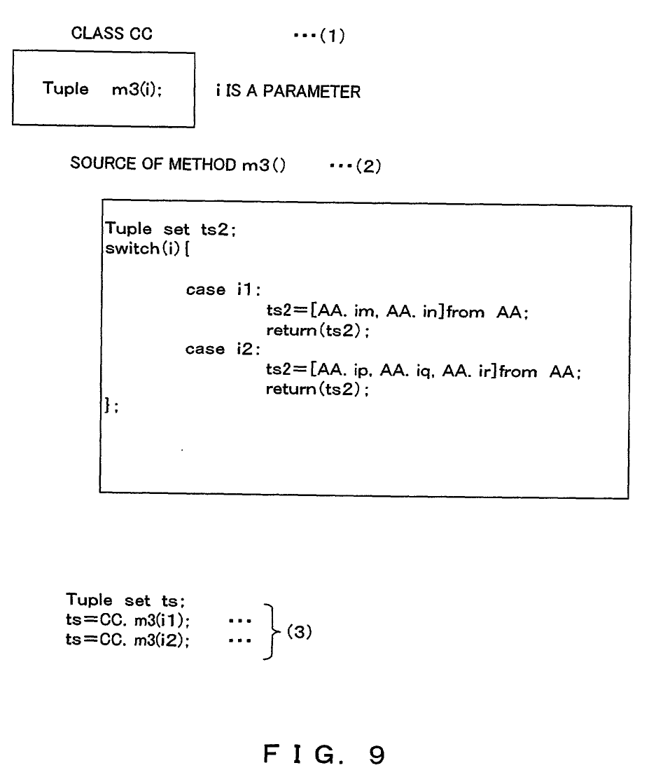

In an object-oriented database, a method can also be defined in a class at the time of data operation, and retrieval and the like can also be conducted in this class. Alternatively, if a class is defined, a schema-variable tuple can also be used for the return value of a method. The case where a schema-variable tuple is used for the return value of a method is described below with reference to FIG. 9. Although the following description assumes that a method is a retrieval procedure, the data operation process is not limited to retrieval.

In (1) of FIG. 9, a method m3( ) with a schema-variable tuple variable as a return value in class CC is defined. The variable management unit 2 stores variable management information which indicates that the return value of the method m3( ) is a schema-variable tuple variable in the variable management information storage unit 7. Here, “i” in the method m3(i) indicates a parameter.

In (2) of FIG. 9, the source of the method m3 ( ) is defined. According to the example shown in (2) of FIG. 9, if parameter i is i1, method m3 ( ) retrieves class AA and obtains the set of tuples having the combination of the value of attribute in and the value of attribute in as their schema. Specifically, the schema of the return value of the method m3 ( ) becomes [M, N]. However, if parameter i is i2, method m3 ( ) retrieves class AA and obtains the set of tuples having the combination of the value of attribute ip, the value of attribute iq and the value of attribute ir as their schema. Specifically, the schema of the return value of method m3 ( ) becomes [P, Q, R]. It is assumed that the class AA shown in FIG. 9 is the same as the class AA described with reference to FIG. 8.

Then, in (3) of FIG. 9, the set ts of schema-variable tuple variables is declared, and the return value of method m3 ( ) is assigned to the variable set ts of variables. If parameter i is i1 or i2, the schema of the return value of method m3 ( ) becomes [M, N] or [P, Q, R], respectively. Since as described above, it is defined that the return value of the method m3 ( ) is a schema-variable tuple in (1) of FIG. 9, method m3 ( ) can use a tuple with a schema that varies depending on the value of parameter i.

As described above, a method using a schema-variable tuple for the return value can be defined, and a class with such a method can be further defined. Therefore, even if the value of a parameter is determined based on a result obtained by calculating the data of a database, a dynamic data operation such that the schema of a return value may vary depending on the parameter value can be executed. Since by doing so, program development restrictions are also reduced, the efficiency of program development can be improved.

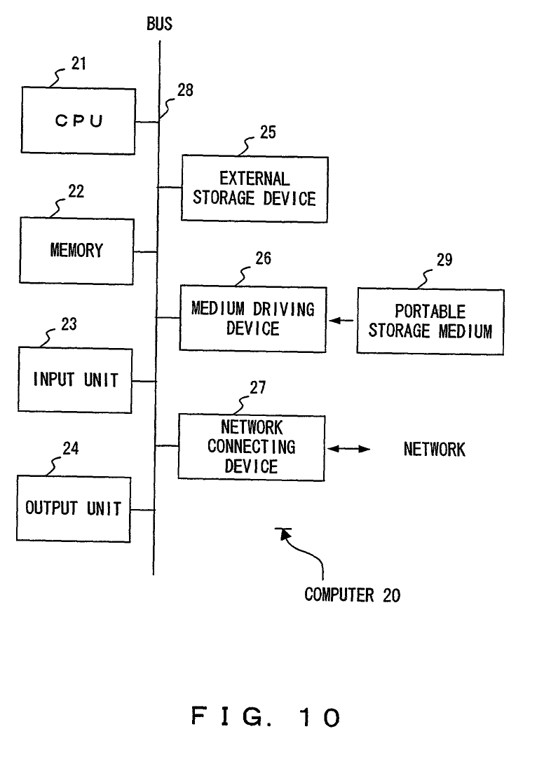

The data operating device described above can be configured using the computer (data processing device) shown in FIG. 10. The computer shown in FIG. 10 comprises a CPU 21, a memory 22, an input device 23, an output device 24, an external storage device 25, a medium driving device 26 and a network connecting device 27, and these devices are connected to each other by a bus 28.

For the memory 22, for example, a ROM (read-only memory) a RAM (random-access memory) or/and the like are used. The memory 22 stores both programs and data used for the process. The CPU 21 implements the function of each unit constituting the data operating device 1 running the program using the memory 22 The variable management unit 2, assignment unit 3, reset unit 4 and data operating unit 5 that constitute the data operating device 1 described above are stored in the specific respective program segments of the memory 22 as programs. Each storage unit constituting the data operating device 1 is stored in the external storage device or memory 22. The input device 23 implements the input unit 9 of the data operating device 1. For the input device 23, for example, a keyboard, a pointing device, a touch panel and the like are used. The input device 23 is used for a user to input both instructions and data. The output device 24 implements the output unit 10 of the data operating device 1. For the output device 24, for example, a display, a printer and the like are used. The output device 24 is used for a computer 20 to output inquiries, process results and the like to a user.

For the external storage device 25, for example, a magnetic disk device, an optical disk device, a magneto-optical disk device and the like are used. This external storage device 25 stores both the programs and data, and the programs and data can be used by loading them into the memory 22, as requested.

The medium driving device 26 drives a portable storage medium 29 and accesses the recorded content. For the portable storage medium 29, any arbitrary computer-readable storage medium, such as a memory card, a memory stick, a flexible disk, a CD-ROM (compact-disk read-only memory), an optical memory, a magneto-optical disk, a DVD (digital versatile disk) and the like can be used. The portable storage medium 29 stores both the programs and data, and both the programs and data can also be used by loading them into the memory 22, as requested.

The network connecting device 27 communicates with an external device through an arbitrary network (line), such as a LAN, WAN and the like, and transmits/receives data accompanying the communications. The network connecting device 27 can also receive the programs from an external device and can use the programs by loading them into the memory 22.

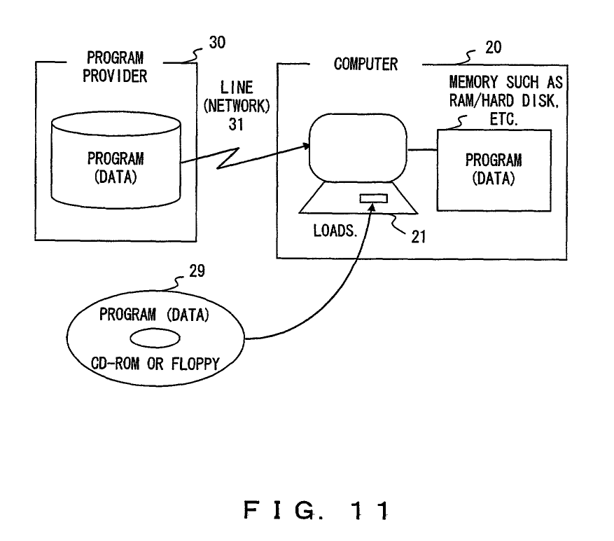

FIG. 11 shows computer-readable storage media, transmission media and signals for supplying the age computer 20, shown in FIG. 10, with the programs.

The present invention can be organized into a program for enabling a computer to implement the same function as that implemented by each constituent component of the preferred embodiment of the present invention described above. The present invention can also be organized into a computer-readable storage medium 29 for recording the programs.

The programs described above are stored in advance in the storage medium 29, are read from the storage medium 29 to the computer 20 using the medium driving device 26 and are temporarily stored in the memory 22 of the computer 20 or the external storage device 25. The CPU 21 with the computer 20 reads and executes these stored programs.

Computer data signals transmitted through a line (network) 31 (transmission medium) when the programs are downloaded from the database of the program provider 30 described above to the computer 20 can also enable the computer 20 to implement functions equivalent to those of the data operating device 1 in the preferred embodiment of the present invention described above.

As described above in detail, the present invention can execute a data operation such that the schema of the operation result may dynamically change, by generating a tuple with an undetermined schema and declaring a variable using the tuple. Furthermore, the load on a program developer in program development and the like can be reduced.

While the invention has been described with reference to the preferred embodiments thereof, various modifications and changes may be made by those skilled in the art without departing from the true spirit and scope of the invention as defined by the claims thereof.

What is claimed is:

1. A computer-readable storage medium for recording a program for enabling a computer to execute a data operation of an object-oriented database, the process comprising:
storing definition information for defining a tuple with an unspecific schema in a storage unit of the computer; and
assigning a tuple with an arbitrary schema to a tuple variable declared using the tuple defined based on the definition information.

2. The storage medium according to claim 1, the process further comprising:
setting type information of the tuple as type information of the tuple variable when assigning the tuple to the tuple variable.

3. The storage medium according to claim 2, the process further comprising:
restoring the setting type information of the tuple variable by resetting the information to an initial state.

4. The storage medium according to claim 1, the process further comprising:
setting the tuple with the unspecific schema in a superclass of all tuple type classes in a hierarchical class structure of the object-oriented database.

5. The storage medium according to claim 1, the process further comprising:
retrieving the object-oriented database; and
assigning data obtained as a result of the retrieval to the tuple variable.

6. The storage medium according to claim 5, the process further comprising:
receiving a condition for retrieving the object-oriented database from an input unit of the computer.

7. A computer-readable storage medium for recording a program for enabling a computer to execute a data operation of an object-oriented database, the process comprising:
storing definition information for defining a tuple with an unspecific schema in a storage unit of the computer; and
using a tuple with an arbitrary schema for a return value of a method when the method uses a tuple defined based on the definition information for the return value.

8. The storage medium according to claim 7, the process further comprising:
retrieving the object-oriented database; and
receiving data obtained as a result of the retrieval of the object-oriented database as the return value of the method.

9. A data operating device for operating on data of an object-oriented database, comprising:
a definition information storage unit storing definition information for defining a tuple with an unspecific schema; and
an assignment unit assigning a tuple with an arbitrary schema to a variable when the variable is declared using the tuple defined based on the definition information.

10. A data operating method for operating on data of an object-oriented database, comprising:
storing definition information for defining a tuple with an unspecific schema in a storage unit; and
assigning a tuple with an arbitrary schema to a tuple variable declared using the tuple defined based on the definition information.

11. The data operating method according to claim 10, further comprising:
setting type information of the tuple as type information of the tuple variable when assigning the tuple to the tuple variable.

12. The data operating method according to claim 11, further comprising:
restoring the setting type information of the tuple variable by resetting the information to an initial state.

13. The data operating method according to claim 10, further comprising:
setting the tuple with the unspecific schema in a superclass of all tuple type classes in a hierarchical class structure of the object-oriented database.

14. The data operating method according to claim 10, further comprising:
retrieving the object-oriented database; and
assigning data obtained as a result of the retrieval to the tuple variable.

15. The data operating method according to claim 14, further comprising:
receiving a condition for retrieving the object-oriented database from an input unit of the computer.

16. A data operating method for operating on data of an object-oriented database, comprising:
storing definition information for defining a tuple with an unspecific schema in a storage unit of the computer; and
using a tuple with an arbitrary schema for a return value of a method when the method uses a tuple defined based on the definition information for the return value.

17. The data operating method according to claim 16, comprising:
retrieving the object-oriented database; and
receiving data obtained as a result of the retrieval of the object-oriented database as the return value of the method.

18. A computer data signal embodied in a carrier wave, for representing a program for enabling a computer to execute a data operation of an object-oriented database, the process comprising:
storing definition information for defining a tuple with an unspecific schema in a storage unit of the computer; and
assigning a tuple with an arbitrary schema to a tuple variable declared using the tuple defined based on the definition information.
